(19) United States
(12) Patent Application Publication
(10) Pub. No.: US 2011/0246871 A1
(43) Pub. Date: Oct. 6, 2011

(54) OPTIMIZED READING EXPERIENCE ON CLAMSHELL COMPUTER

(75) Inventors: Jerry T. Paradise, Durham, NC (US); Masaki Matsubara, Sagamihara-shi (JP); Paul Plaskonos, Raleigh, NC (US); Ratan Ray, Cary, NC (US); Rory P. Read, Raleigh, NC (US)

(73) Assignee: Lenovo (Singapore) Pte.Ltd., Singapore (SG)

(21) Appl. No.: 12/751,341

(22) Filed: Mar. 31, 2010

(51) Int. Cl. G09G 5/00; G06F 17/00; G06F 3/048; G06F 3/02; G06F 3/033; G06F 3/041

(52) U.S. Cl. 715/253; 715/784; 345/156; 345/168; 345/163; 345/173

(57) ABSTRACT

The provision of an optimized arrangement for reading tasks at a clamshell or laptop computer, particularly to facilitate reading in portrait mode. Further contemplated herein are arrangements for readily switching between a reading (portrait) operating mode and a “normal” (landscape) mode. Such changes could be brought about via essentially any suitable arrangement, such as via an accelerometer which acts automatically, or a hotkey which is activated manually. Additionally contemplated herein is the use of mouse keys for alternative purposes specific to switching between the reading/portrait modes, such as utilizing left and right mouse buttons for page up and page down controls for reading (in portrait mode). A mouse pad (touchpad) can also be employed for alternative purposes in reading/portrait mode, such as the use of horizontal mouse pad scrolling for vertical document scrolling in reading/portrait mode.

### BACKGROUND

“Clamshell” computers are portable computers having a compact closed configuration for transport and having an open configuration wherein a display swings our for viewing and for use of the computer. Clamshell computers typically comprise a base having a front, a rear, an upper side and a bottom, human interface devices (i.e., keyboard, touch pad, mouse, etc.) mounted on the upper side of the base and adjacent to the front of the base, a display housing with a display, the display housing being pivotally mounted on the base from a rear end of the display housing on a horizontal pivot axis, such that in a closed position the display housing covers the keyboard and in an open position the display housing is pivoted back to expose the keyboard, with the display mounted in the housing such that it is in convenient view to an operator in front of the keyboard, and an arrangement which holds the display housing and display at an open position rearwardly inclined with respect to the base and convenient for view. Typically, the display is close to the keyboard and to the user in the open position of the computer, and the display housing encloses and protects the keyboard in the closed position of the computer.

Clamshell computers, such as hinged laptop computers, often if not always present the disadvantage that reading can be a difficult, cumbersome and altogether unsatisfying exercise. For one thing, the screen is physically separated from the user by the keyboard, thus increasing the reading distance at hand. Further, as clamshell computers normally have screens that have a longer horizontal dimension than that rectilinear dimension perpendicular thereto, documents either appear in landscape mode or in a highly truncated portrait mode. Since users generally are accustomed to reading books or other paper documents in portrait mode, the experience of reading in landscape or truncated portrait mode can often be uncomfortable and straining. Finally, merely rotating the image on the screen will not only make it problematic to read, but will present problems for navigating the document being read.

### BRIEF SUMMARY

Arrangements are disclosed for readily switching in between a reading (portrait) operating mode and a “normal” (landscape) mode. Such changes could be brought about via essentially any suitable arrangement, such as via an accelerometer which acts automatically, or a hotkey which is activated manually.

Additionally contemplated herein is the use of mouse keys for alternative purposes specific to the reading/portrait mode, such as utilizing left and right mouse buttons for page up and page down controls for reading (in portrait mode). A mouse pad can also be employed for alternative purposes in reading/portrait mode, such as the use of horizontal mouse pad scrolling for vertical document scrolling in reading/portrait mode.

Yet further contemplated herein is the employment of brightness and/or contrast optimization for use in the reading/portrait mode.

In summary, one embodiment provides an apparatus comprising: a clamshell computer; the clamshell computer comprising: a main memory; one or more processors; a first body portion and a second body portion, the first body portion being hingedly connected to the second body portion; and a computer screen disposed on the first body portion; the clamshell computer further comprising a computer readable storage medium having computer executable program code embodied therewith and executable by the one or more processors, the computer executable program code comprising: computer executable program code configured to display a document on the computer screen; and computer executable program code configured to reorient a document displayed on the computer screen responsive to a one-step trigger, the reorienting comprising reorienting an upper visual edge of the document from a first position to a second position, the first position corresponding to a first angle of the upper visual edge of the document with respect to a reference axis of the computer screen and the second position corresponding to a second angle of the upper visual edge of the document with respect to a reference axis of the computer screen, the first and second angles being different from one another.

Another embodiment provides an apparatus comprising: one or more processors; and a computer readable storage medium having computer executable program code embodied therewith and executable by the one or more processors, the computer executable program code comprising: computer executable program code configured to display a document on a computer screen; and computer executable program code configured to reorient a document displayed on a computer screen responsive to a one-step trigger, the reorienting comprising reorienting an upper visual edge of the document from a first position to a second position, the first position corresponding to a first angle of the upper visual edge of the document with respect to a reference axis of the computer screen and the second position corresponding to a second angle of the upper visual edge of the document with respect to a reference axis of the computer screen, the first and second angles being different from one another; the reference axis being parallel to a hinge axis of a clamshell computer.

A further embodiment provides a method comprising: displaying a document on a computer screen; and responsive to a one-step trigger, reorienting an upper visual edge of the document from a first position to a second position, the first position corresponding to a first angle of the upper visual edge of the document with respect to a reference axis of the computer screen and the second position corresponding to a second angle of the upper visual edge of the document with respect to a reference axis of the computer screen, the first and second angles being different from one another; the reference axis being parallel to a hinge axis of a clamshell computer.

An additional embodiment provides a computer program product comprising: a computer readable storage medium embodying executable program code comprising: computer executable program code configured to display a document on a computer screen; and computer executable program code configured to reorient a document displayed on the computer screen responsive to a one-step trigger, the reorienting comprising reorienting an upper visual edge of the document from a first position to a second position, the first position corresponding to a first angle of the upper visual edge of the document with respect to a reference axis of the computer screen and the second position corresponding to a second angle of the upper visual edge of the document with respect to a reference axis of the computer screen, the first and second angles being different from one another; the reference axis being parallel to a hinge axis of a clamshell computer.

For a better understanding of exemplary embodiments, together with other and further features thereof, reference is made to the following description, taken in conjunction with the accompanying drawings, and the scope of the claimed embodiments will be pointed out in the appended claims.

### BRIEF DESCRIPTION OF THE SEVERAL VIEWS OF THE DRAWINGS

FIG. 1 illustrates a computer system.

FIG. 2 shows in perspective elevational view a clamshell or laptop computer with the screen in “landscape” orientation.

FIG. 3 shows in perspective elevational view the clamshell or laptop computer of FIG. 2, with the screen in “portrait” orientation.

FIG. 4 shows in perspective plan view a clamshell or laptop computer, additionally showing components for facilitating an easy transition between different orientations of the computer.

FIG. 5 shows in perspective plan view the clamshell or laptop computer of FIG. 4.

### DETAILED DESCRIPTION

It will be readily understood that the components of the embodiments, as generally described and illustrated in the figures herein, may be arranged and designed in a wide variety of different configurations in addition to the described exemplary embodiments. Thus, the following more detailed description of the embodiments, as represented in the figures, is not intended to limit the scope of the claims, but is merely representative of exemplary embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding thereof. One skilled in the relevant art will recognize, however, that the various embodiments can be practiced without one or more of the specific details, or with other methods, components, materials, et cetera. In other instances, well-known structures, materials, or operations are not shown or described in detail to avoid obscuring aspects thereof.

The description now turns to the figures. The illustrated embodiments are best understood by reference to the figures. The following description is intended only by way of example and simply illustrates certain selected exemplary embodiments.

It should be noted that the flowchart and block diagrams in the figures illustrate the architecture, functionality, and operation of possible implementations of systems, apparatuses, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

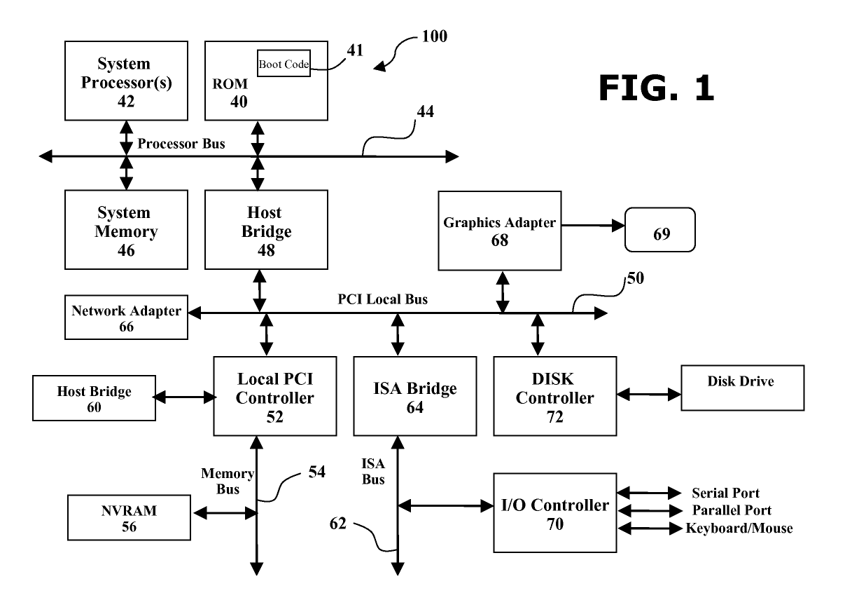

Referring now to FIG. 1, there is depicted a block diagram of an illustrative embodiment of a computer system 100. The illustrative embodiment depicted in FIG. 1 may be an electronic device such as a laptop or desktop personal computer, a mobile/smart phone or the like. As is apparent from the description, however, embodiments may be implemented in any appropriately configured device, as described herein.

As shown in FIG. 1, computer system 100 includes at least one system processor 42, which is coupled to a Read-Only Memory (ROM) 40 and a system memory 46 by a processor bus 44. System processor 42, which may comprise one of the AMD line of processors produced by AMD Corporation or a processor produced by INTEL Corporation, is a general-purpose processor that executes boot code 41 stored within ROM 40 at power-on and thereafter processes data under the control of an operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN, and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a as a keyboard, mouse, serial and parallel ports, et cetera. A disk controller 72 connects a disk drive with PCI local bus 50. The USB Bus and USB Controller (not shown) are part of the Local PCI controller (52).

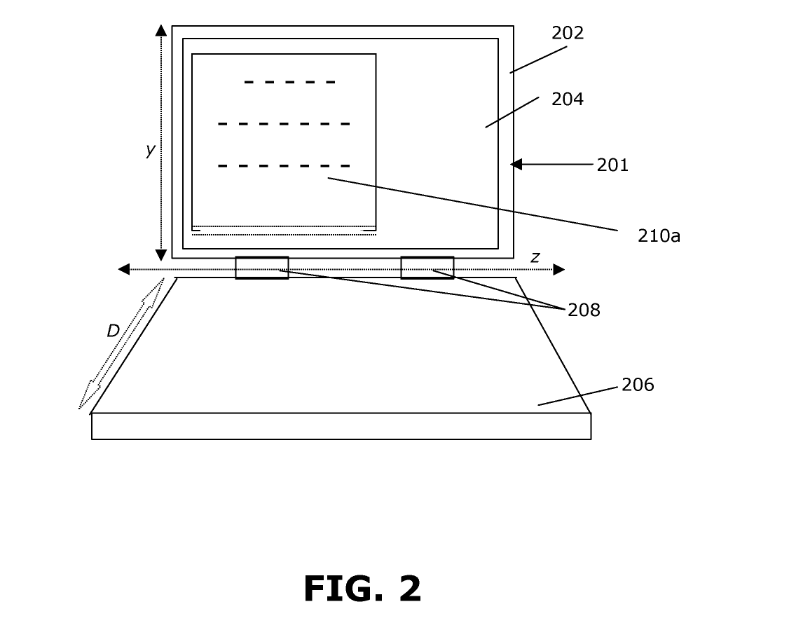

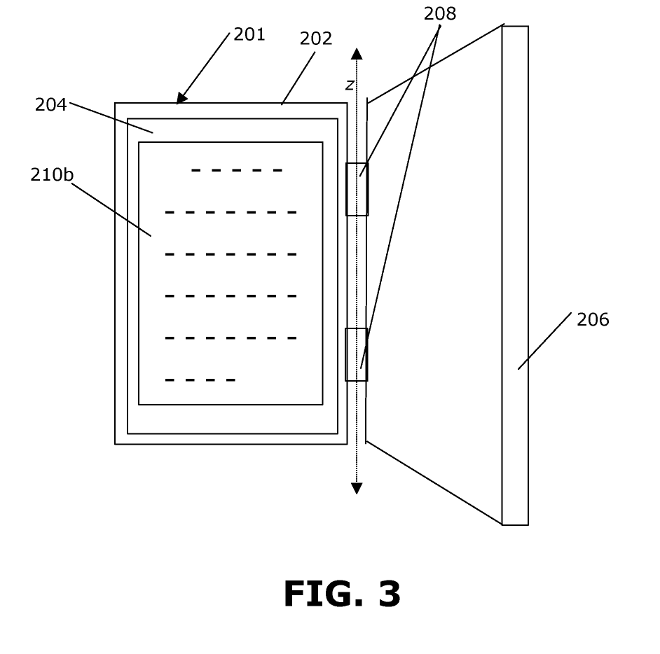

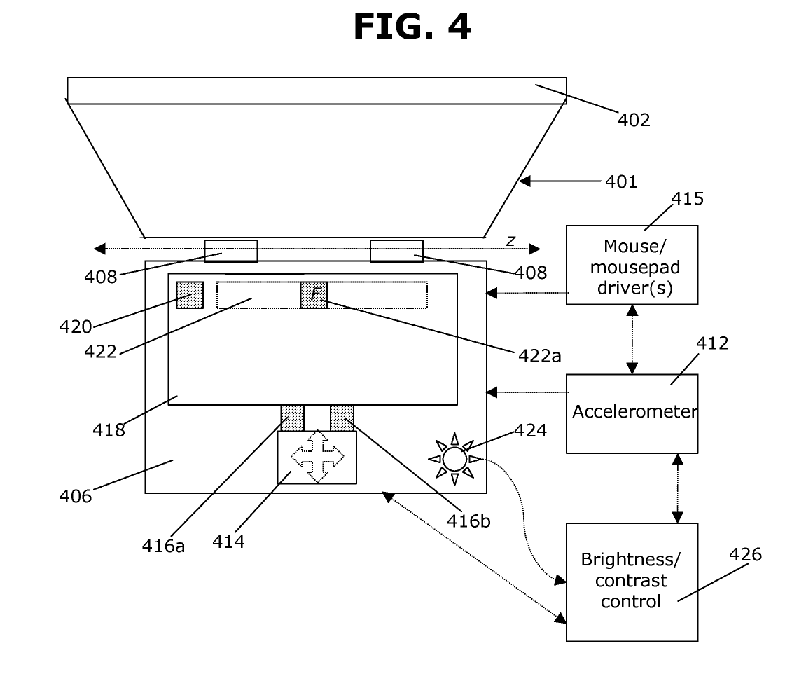

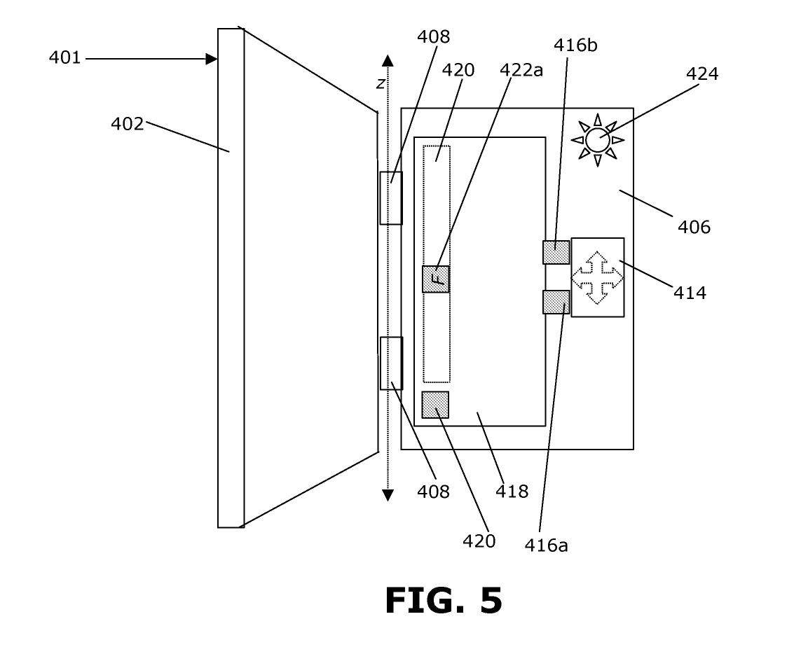

FIG. 2 shows in perspective elevational view a clamshell or laptop computer 200 with the screen in “landscape” or generally horizontal orientation. Generally, it should be noted that for the purposes of discussion herein, the terms “clamshell” and “laptop” may essentially be considered to be interchangeable, referring to a computer with two portions hingedly connected with one another. Also, it should be understood that computer 201 shown in FIGS. 2 and 3, as well as that indicated at 401 in FIGS. 4 and 5, may be embodied internally by essentially any suitable computer system, such as (but by no means limited to) that indicated at 100 in FIG. 1.

As shown, a clamshell computer may typically include an upper portion 202, which includes screen 204, and a lower portion 206. Upper and lower portions 202/206 are typically hingedly connected with one another via suitable hinges 208 or other analogously functioning mechanism(s) for affording relative pivotal displacement of the upper and lower portions 202/206 with respect to one another. Typically, as is well-known, lower portion 206 will include a keyboard and other user controls.

As is typically the case in clamshell computers, the screen 204 will have a longer dimension in parallel to the hinge axis z than in parallel to the axis y that is orthogonal to z (and in parallel with a main plane of screen 204). Accordingly, a typical document 210a, if not displayed in landscape mode (that is, where, similarly to the screen 204, the dimension of the document parallel to axis z is greater than the dimension parallel to y), will typically undergo an accommodation that might not provide optimal viewing for a user. Particularly, for a document 210a shown in portrait view (that is, where the dimension of a page of the document parallel to y is greater than the dimension parallel to z), the document 210a will typically need to be visually truncated as shown, at least to provide some reasonable level of readability. In other words, in order to maintain a text size and/or font appearance sufficient for promoting readability, a document 210a can rarely be shown an entire page at a time in portrait view in a typical clamshell computer context, especially accounting for the distance D, along a dimension orthogonal to the hinge axis z with respect to the lower portion 206, that a user's eyes need to traverse in order to see whatever is on the screen 204.

FIG. 3 shows in perspective elevational view the clamshell or laptop computer of FIG. 2, with the screen 204 in “portrait” or generally vertical orientation. In other words, the computer 201 has been reoriented so that the z axis is now essentially orthogonal to the orientation shown in FIG. 2, now running primarily vertically instead of virtually horizontally. As such, it would now be possible, in most clamshell computer settings, to display a document 210b one full page at a time in portrait view, without any need to visually truncate the page. This can provide tremendous advantages to the user, in that a distance D (as shown in FIG. 2) no longer needs to be visually traversed, while no scrolling needs to take place to view a document page (in portrait mode) that more or less is in readable format (e.g., has a text size and font appearance the promotes reasonable viewing for users with standard visual acuity). In some conventional arrangements, it is possible to change display properties of the computer 201 so as to permit viewing of a document 210b in portrait mode as shown in FIG. 3. However, this can be a time-consuming and cumbersome process.

FIG. 4 shows in perspective plan view a clamshell or laptop computer 401, additionally showing components, in accordance with at least one embodiment, for facilitating an easy transition between different orientations of the computer. FIG. 5 shows in perspective plan view the clamshell or laptop computer of FIG. 4. Thus, the orientations of computer 401 shown in FIGS. 4 and 5, respectively, are essentially analogous to the orientations of computer 201 shown in FIGS. 2 and 3, respectively.

It should be noted that in FIGS. 4 and 5, any components or elements that essentially are similar or like or analogous with respect to components or elements shown in FIGS. 2 and 3, bear reference numerals advanced by 200. Reference will continue to be made to both FIGS. 4 and 5.

As a first possible mechanism for transitioning between the orientation of FIG. 4 and that of FIG. 5, in accordance with certain embodiments, an accelerometer 412 may preferably be provided in or at computer 401. Accelerometer 412 can detect when the z axis has transitioned from a primarily horizontal orientation (e.g., as in FIG. 4) to a primarily vertical one (e.g., as in FIG. 5) and/or from a primarily vertical orientation to a primarily horizontal one. Criteria for determining when a “primarily horizontal” or “primarily vertical” orientation is achieved (such as, defining a transition point into or out of “primarily horizontal” or “primarily vertical” in terms of an angle of axis z with respect to the horizontal) can be pre-set with the accelerometer 412. When such a detection has been made, accelerometer 412 may preferably prompt one or more viewing-related actions that facilitate the reading of a document or other item on the screen in upper portion 402. “Transition” angles of axis z with respect to the horizontal, as just discussed, can be pre-set by a user, e.g. in accord with a user's preference, as can acceleration or deceleration conditions that could prompt one or more viewing-related actions.

Whereas accelerometer 412 provides a type of automatic trigger mechanism to prompt viewing-related actions to be further appreciated below, manual trigger arrangements are also contemplated Particularly, a “hotkey” 420, or key dedicated for the purpose, may be provided on keyboard 418 which, when activated, could trigger viewing-related actions as to be described here below. Another trigger could be in the form of a single function key 422a as found in row of function keys 422 on keyboard 418. Other manual triggers could take the form of a simple combination of keys on keyboard 418, such as a CTRL+ALT combination with another key, or the ALT key combined with another key, a gesture on the screen (which could be in the form of a touch screen) or mousepad 412. In a variant embodiment, an optional parameter could be employed wherein the screen is adjusted only when one or more pre-selected, or customer selected, applications are running, such as e-reader applications.

Generally, a viewing-related action as referred to above could be a transition of a document from an orientation where the longitudinal dimension (or longer dimension of a page) of the document in portrait mode is parallel to an axis which is orthogonal to hinge axis z (e.g., similarly to the orientation of document 210a in FIG. 2) to one where the longitudinal dimension (or longer dimension of a page) of the document in portrait mode is parallel to the hinge axis z (e.g., similarly to the orientation of document 210b in FIG. 3). More generally, such an action can take place when the computer 401 is transitioned from a more or less horizontal orientation (as in FIGS. 2 and 4) to a more or less vertical orientation (as in FIGS. 3 and 5), whether triggered automatically (e.g., with an accelerometer 412) or manually by the user (e.g., via hotkey 420, function key 422a or a key combination as just described).

Computer 401 may include a mousepad 414 (i.e., a touchpad that can simulate or manifest mouse-type movements, that is, direct a cursor or other element on a screen to move responsive to touch movements across pad 414) and left and right “mouse” buttons 416a, 416b, respectively. These can function, in a standard operating condition of computer 414, in known conventional manner.

However, in accordance with certain embodiments, the function of mousepad (or touchpad) 414 and/or buttons 416a, 416b essentially can be transformed in response to the automatic or manual triggers discussed above. Particularly, once accelerometer 412 or a manual trigger mechanism (e.g., 420 or 422) detects or manifests a document viewing transition associated with a change from an primarily horizontal orientation to an primarily vertical orientation of computer 401, mouse or mousepad driver(s) 415 may preferably be prompted to alter the function of mousepad 414 and/or buttons 416a, 416b so as to work more logically or appropriately in relation to a document in full portrait mode (e.g., similar to document 210b in FIG. 3). Particularly, for instance, inasmuch as mousepad 414 and buttons 416a, 416b can be employed to scroll within a document (left/right scrolling in the case of buttons 416a, 416b and scrolling in any direction by appropriately sweeping a finger on mousepad 414), normally these functions would not change if the computer were moved from a horizontal orientation (as in FIGS. 2 and 4) to a vertical orientation (as in FIGS. 3 and 5).

However, in accordance with certain embodiments, upon a triggering action as discussed above (e.g., via accelerometer 412 or keys 420/422a or via other media), mouse/mousepad driver(s) 415 will be prompted to re-map the functioning of mousepad 414 and/or mouse buttons 416a, 416b so that they will now perform more suitably in relation to any re-oriented document (e.g., a portrait document 210b as in FIG. 3). Particularly, if the orientation of FIG. 5 is considered, button 416b may function as a “scroll up” button while button 416a may function as a “scroll down” button. These two functions could even be reversed if computer 401 had an primarily vertical orientation but portion 406 were disposed to the left and portion 402 to the right. Similarly, sweeps of a finger on mousepad 414 could, in the primarily vertical orientation of FIGS. 3 and 5, preferably be translated to actions with respect to a document in full portrait mode (e.g., as document 210b in FIG. 3) that are most suitable for such a document. Thus, in an primarily vertical orientation of computer 401 as in FIG. 5, a finger sweep up or down could translate to a scroll-up or scroll-down, respectively, in a document in full portrait mode (e.g., as document 210b in FIG. 3).

In contrast, it will be appreciated that without any re-mapping as broadly contemplated herein and as discussed above, elements such as mouse buttons 416a, 416b and mousepad 414 will continue to operate, in an primarily vertical orientation of computer 401 (as in FIGS. 3 and 5), as if a document were still oriented similarly to that indicated at 210a in FIG. 2 (e.g., a truncated portrait mode or even a landscape mode). Thus, without re-mapping, the right mouse button 416b would translate, e.g., to a scroll-right action with respect to a full portrait document (such as document 210b in FIG. 2) and left mouse button 416a would translate, e.g., to a scroll-left action with respect to a similar document. A mousepad 414 would present similar problems, meaning that a user would undertake given actions that would produce a completely counterintuitive result (e.g., pushing an “upper” button such as 416b in FIG. 5 and seeing a scroll-right actually take place on the screen).

Indicated at 426 is a brightness/contrast control of computer 401 which, optionally in conjunction with a light sensor 424 (which essentially may be disposed anywhere on the computer 401, shown here in the indicated location merely by way of illustrative and non-restrictive example), can be employed advantageously. Particularly, upon accelerometer detecting that computer 402 has transformed from an primarily horizontal to an primarily vertical orientation, it may preferably direct brightness/contrast control 426 to change the brightness or contrast on the computer screen to be more consistent with a closer reading of a document. Thus, for instance, the screen could come to appear less bright, or to adopt a less pronounced contrast, than it would have with the computer 401 in an primarily horizontal orientation.

Light sensor 424 assesses ambient light conditions and tailors a light/contrast “protocol” accordingly. For instance, light sensor 424 could convey to brightness/contrast control an ambient condition that is used as a “starting point” for determining the degree to which, e.g., dimming or a change in contrast takes place on the screen as the computer 401 transforms from an primarily horizontal to an primarily vertical orientation. In a variant embodiment, a camera on computer 401 (e.g. built-in or mounted-on) could be used as an ambient light sensor.

Preferably, when computer 401 transforms from an primarily vertical to an primarily horizontal orientation, the above-described phenomena may take place in reverse. Thus, the screen could become brighter, or adopt a more pronounced contrast, than it would have with the computer 401 in an primarily vertical orientation. Light sensor 424 could still act to assess ambient conditions and provide a “starting point” to guide brightness/contrast control 426, as just discussed.

If an accelerometer 412 is not used then, of course, a manual arrangement such as keys 420/422a could be employed to trigger the brightness/contrast control 426 to change the brightness or contrast of the screen.

It is contemplated to control other aspects of screen appearance as the computer 401 transforms from a primarily horizontal to a primarily vertical orientation, or vice versa (whether triggered by an accelerometer 412 or a manual arrangement such as a key 420/422a). For instance, as computer 401 transforms from an primarily horizontal to an primarily vertical orientation, the font size/appearance/color and/or background features could be changed to be more conducive to closer reading, or even to adopt an appearance preselected by the user (e.g., a customizable “reading appearance”). Thus, e.g., a font could be changed and/or the font size reduced and/or a differently colored document background manifested. Analogous changes could be made in reverse (as the computer 401 transforms from a primarily vertical to an primarily horizontal orientation). Actions other than changes in screen appearance could also take place as computer 401 transforms from a primarily horizontal to a primarily vertical orientation, vice versa. For instance, computer 401 could go into a low-power mode which could involve any or all of: a low power processor mode, disabling of optical media devices, activation of hard drive idle timers etc.

Generally, it should be understood and appreciated that, to the extent not specifically pointed out hereinabove, all actions that take place or result in transforming from an primarily horizontal to an primarily vertical orientation of a clamshell or laptop computer may act analogously in reverse. Thus, if a screen and/or document takes on a first given appearance or set of characteristics when the computer is in an primarily horizontal orientation, and then takes on a second given appearance or set of characteristics when the computer is in an primarily vertical orientation, then the screen and/or document may return to the first given appearance or set of characteristics when the computer returns from an primarily vertical to an primarily horizontal orientation

It should be understood and appreciated that the terms “primarily horizontal” and “primarily vertical”, as broadly employed herein, may be taken to be indicative of a range of orientations of a computer when, respectively, the computer generally tends towards a horizontal orientation or vertical orientation (as can be defined by the relationship of the hinge axis or z-axis to true horizontal or true vertical, respectively). The respective ranges of orientations corresponding to “primarily horizontal” or “primarily vertical” may be predefined in accordance with an algorithm that, for instance, assigns a given range of angles (e.g., of the hinge axis or z-axis with respect to true horizontal or true vertical) to either “primarily horizontal” or “primarily vertical”. For instance, such an algorithm may treat any orientation of the hinge axis or z-axis that is about 45 degrees or less with respect to true horizontal as “primarily horizontal”, while treating any orientation of the hinge axis or z-axis that is about 45 degrees or more with respect to true horizontal as “primarily vertical”. In an alternative embodiment, the transition could be triggered in either direction as the z-axis gets even closer to true vertical or true horizontal, e.g., within 30 or so degrees of either.

To the extent that “primarily vertical” orientations are discussed herein, it should be understood and appreciated that two different “primarily vertical” orientations are contemplated. A first such orientation is evident from FIGS. 3 and 5, where the right-hand portion of a computer is positioned higher than the left-hand portion of the computer. A second “primarily vertical” orientation, then, would essentially be the opposite of what is shown in FIGS. 3 and 5, where a left-hand portion of a computer would be positioned higher than the right-hand portion of the computer. In various embodiments, any algorithm for effecting changes to a screen or document appearance, as a computer transforms from a primarily horizontal to a primarily vertical orientation, may be particularly tailored to whether the computer is transforming into the “first” or “second” primarily vertical orientation as just discussed For instance, in the “first” primarily vertical orientation (as in FIGS. 3 and 5), the top of a document may preferably be disposed towards what is now the “top” of the computer, that is, the nominally right-hand portion of the computer. On the other hand, in the “second” primarily vertical orientation (essentially the opposite of FIGS. 3 and 5), the top of a document may preferably be disposed towards the nominally left-hand portion of the computer.

To the extent that “automatic” and “manual” triggering arrangements have been discussed heretofore, e.g., in the context of an accelerometer or keyboard keys, respectively, it is further contemplated that both such triggering arrangements may be present in a computer, and that one could even override the other. For instance, even in the presence of an automatic triggering arrangement in the form of an accelerometer, it is contemplated to override this function merely by employing, e.g., a hotkey or function key manually. Such an overriding action could act to disable the automatic triggering arrangement for a set time or until a given set of conditions is met (e.g., the computer transforms from one orientation to another).

To the extent that arrangements for controlling brightness and/or contrast have been discussed hereinabove, essentially any protocol can be applied to determine the specific levels of brightness or contrast that can be employed as the computer is in one orientation or another. For instance, empirical calculations may be predetermined to then preset the computer (e.g., at the factory) to use one level of brightness or contrast or the other at for one orientation of the computer or the other. On the other hand, the user could preset or change such levels through a suitable user interface. Again, any brightness or contrast level can be modified in view of ambient conditions as determined, e.g., by a light sensor.

It should be noted that features described herein may be embodied as a system, method or computer program product. Accordingly, the features may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, those features may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations may be written in any combination of one or more programming languages, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Features are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments have been described herein with reference to the accompanying drawings, it is to be understood that embodiments are not limited to those particular descriptions, and that various other changes and modifications may be affected therein by one skilled in the art without departing from the scope or spirit of the disclosure.

What is claimed is:

1. An apparatus comprising:
a clamshell computer;
said clamshell computer comprising:
a main memory;
one or more processors;
a first body portion and a second body portion, said first body portion being hingedly connected to said second body portion; and
a computer screen disposed on said first body portion;
said clamshell computer further comprising a computer readable storage medium having computer executable program code embodied therewith and executable by the one or more processors, the computer executable program code comprising:
computer executable program code configured to display a document on said computer screen; and
computer executable program code configured to reorient a document displayed on said computer screen responsive to a one-step trigger, the reorienting comprising reorienting an upper visual edge of the document from a first position to a second position, the first position corresponding to a first angle of the upper visual edge of the document with respect to a reference axis of said computer screen and the second position corresponding to a second angle of the upper visual edge of the document with respect to a reference axis of said computer screen, the first and second angles being different from one another.

2. The apparatus according to claim 1, wherein the first and second angles are offset from one another by about ninety degrees.

3. The apparatus according to claim 1, wherein the one-step trigger comprises an automatic trigger.

4. The apparatus according to claim 3, further comprising an accelerometer configured to provide the automatic trigger.

5. The apparatus according to claim 3, further comprising computer executable program code configured to activate the automatic trigger responsive to reorientation of the computer screen on which the document is displayed.

6. The apparatus according to claim 5, further comprising computer executable program code configured to activate the automatic trigger responsive to a change in orientation of the reference axis.

7. The apparatus according to claim 1, wherein the one-step trigger comprises a manual trigger.

8. The apparatus according to claim 7, further comprising a hotkey configured to provide the manual trigger.

9. The apparatus according to claim 7, further comprising a keyboard.

10. The apparatus according to claim 9, wherein:
said keyboard comprises a function key that is configured to provide the manual trigger.

11. The apparatus according to claim 9, wherein further comprising computer executable program code configured to activate the manual trigger via a key combination on said keyboard.

12. The apparatus according to claim 1, wherein:
said clamshell computer comprises a hinge axis about which said first and second body portions are hingedly displaceable with respect to one another; and
the reference axis is parallel to said hinge axis.

13. The apparatus according to claim 1, further comprising:
a mouse key; and
computer executable program code configured to remap the function of said mouse key responsive to the one-step trigger.

14. The apparatus according to claim 1, further comprising:
two mouse keys; and
computer executable program code configured to remap the function of two mouse keys responsive to the one-step trigger.

15. The apparatus according to claim 14, wherein the computer executable program code is further configured to remap the function of said two mouse keys to newly prompt scrolling of a document displayed on the computer screen essentially along a direction parallel to an axis interconnecting said two mouse keys.

16. The apparatus according to claim 1, further comprising:
a touchpad; and
computer executable program code configured to remap the function of said mousepad responsive to the one-step trigger.

17. The apparatus according to claim 1, further comprising computer executable program code configured to change an appearance of said document on said screen responsive to the one-step trigger.

18. The apparatus according to claim 1, further comprising computer executable program code configured to change an appearance of said screen responsive to the one-step trigger.

19. The apparatus according to claim 18, wherein the computer executable program code is configured to change a brightness of said computer screen responsive to the one-step trigger.

20. The apparatus according to claim 18, wherein the computer executable program code is configured to change a contrast of said computer screen contrast responsive to the one-step trigger.

21. The apparatus according to claim 18, wherein the computer executable program code is configured to govern a change in said computer screen appearance based on sensed ambient light conditions.

22. The apparatus according to claim 21, further comprising a light sensor configured to sense ambient light conditions.

23. An apparatus comprising:
one or more processors; and
a computer readable storage medium having computer executable program code embodied therewith and executable by the one or more processors, the computer executable program code comprising:
computer executable program code configured to display a document on a computer screen; and
computer executable program code configured to reorient a document displayed on a computer screen responsive to a one-step trigger, the reorienting comprising reorienting an upper visual edge of the document from a first position to a second position, the first position corresponding to a first angle of the upper visual edge of the document with respect to a reference axis of the computer screen and the second position corresponding to a second angle of the upper visual edge of the document with respect to a reference axis of the computer screen, the first and second angles being different from one another;
said reference axis being parallel to a hinge axis of a clamshell computer.

24. A method comprising:
displaying a document on a computer screen; and
responsive to a one-step trigger, reorienting an upper visual edge of the document from a first position to a second position, the first position corresponding to a first angle of the upper visual edge of the document with respect to a reference axis of the computer screen and the second position corresponding to a second angle of the upper visual edge of the document with respect to a reference axis of the computer screen, the first and second angles being different from one another;
the reference axis being parallel to a hinge axis of a clamshell computer.

25. A computer program product comprising:
a computer readable storage medium embodying executable program code comprising:
computer executable program code configured to display a document on a computer screen; and
computer executable program code configured to reorient a document displayed on said computer screen responsive to a one-step trigger, the reorienting comprising reorienting an upper visual edge of the document from a first position to a second position, the first position corresponding to a first angle of the upper visual edge of the document with respect to a reference axis of said computer screen and the second position corresponding to a second angle of the upper visual edge of the document with respect to a reference axis of said computer screen, the first and second angles being different from one another;
the reference axis being parallel to a hinge axis of a clamshell computer.
